(19) United States
(12) Patent Application Publication
(10) Pub. No.: US 2015/0181560 A1
(43) Pub. Date: Jun. 25, 2015

(54) METHOD AND SYSTEM OF COMMUNICATION WITH LOW COST MACHINE TYPE COMMUNICATION DEVICES

(71) Applicant: Samsung Electronics Co., Ltd., Suwon-si, Gyeonggi-do (KR)

(72) Inventors: Satish Nanjunda Swamy Jamadagni, Bangalore (IN); Venkateswara Rao Manepalli, Bangalore (IN); Sarvesha Anegundi Ganapathi, Bangalore (IN)

(21) Appl. No.: 14/415,931

(22) PCT Filed: Aug. 14, 2013
(86) PCT No.: PCT/KR2013/007358

§ 371 Date: Jan. 20, 2015

(30) Foreign Application Priority Data
Aug. 14, 2012 (IN) 3373/CHE/2012

(51) Int. Cl. H04W 72/04; H04W 4/00

(52) U.S. Cl. CPC H04W 72/04; H04W 4/005

(57) ABSTRACT

The present invention provides a method and system of communication with low cost Machine Type Communication (MTC) devices. In one embodiment, a MTC device transmits capability information to a base station. The capability information includes identity associated with the MTC device, an operating frequency and an operating bandwidth supported by the MTC device, antenna configuration information, support for number of radio frequency (RF) chains, and/or half duplex configuration. The base station tunes the MTC device to the operating frequency and the operating bandwidth supported by the MTC device based on the capability information. The base station sends a message indicating the MTC device to be tuned to the operating frequency and/or the operating bandwidth. Accordingly, the base station and the MTC device exchange messages (control messages and/or data messages) within the operating bandwidth over the operating frequency.

### TECHNICAL FIELD

The present invention generally relates to the field of wireless communication, and more particularly relates to method and system of communication with low cost machine type communication (MTC) devices.

### BACKGROUND ART

Long Term Evolution (LTE) is a technology that is being standardized by Third Generation Partnership Project (3GPP) forum as part of the 4th generation wireless network evolution. LTE is flexible on spectrum requirement point and can operate in different frequency bands (1.25, 1.6, 2.5, 5, 10, 15 and 20 MHz). LTE can also operate in unpaired as well as paired spectrum. From a user equipment perspective, it is mandatory in LTE for user equipments to support 20 MHz frequency band.

As LTE wireless communication networks evolve, network operators would like to reduce the cost of overall network maintenance by minimizing number of Radio Access Technologies (RATs) between MTC devices in the network. Machine type communications is likely to continue to expand in the future due to the rise of applications such as a smart metering, commercial fleet tracking, etc. transmitting and receiving data. In an example, many existing MTC devices (e.g., MTC User Equipments) are currently targeted at low-end (e.g., low average revenue per user, low data rate) applications that can be handled adequately by Global System for Mobile communications (GSM)/General Packet Radio Service (GPRS) networks.

### DISCLOSURE OF INVENTION

### Technical Problem

Owing to the low cost of these MTC devices and the good coverage of GSM/GPRS, there has been very little motivation for MTC device suppliers to use modules that support LTE radio interface. However, as more MTC devices are deployed in the wireless communication network, there will be an increased reliance on the existing GSM/GPRS networks. Thus, this will cost network operators not only in terms of maintaining multiple RATs but it will also prevent operators from reaping the maximum benefit out of their spectrum, especially given the non-optimal spectrum efficiency of GSM/GPRS.

### Solution to Problem

Given the likely high number of MTC devices in the future, the overall resource they will need for service provision may be significant and inefficiently assigned. Therefore, it is desirable to provide, for example, a low cost and low power MTC device which has a simple operational procedure to enable low operational cost to MTC operators and which can facilitate migration of MTC devices from the GSM/GPRS networks to LTE networks.

### BRIEF DESCRIPTION OF DRAWINGS

FIG. 1 illustrates a block diagram of an exemplary wireless communication system, according to one embodiment.

FIG. 2 is a process flowchart illustrating an exemplary method of tuning a low cost Machine Type Communication (MTC) device to an operating frequency and operating bandwidth supported by the MTC device, according to one embodiment.

FIG. 3 is a flow diagram illustrating an exemplary method of changing operating frequency and/or operating bandwidth of the MTC device, according to one embodiment.

FIGS. 4A to 4C are schematic representations illustrating tuning of the MTC device to different operating frequencies and different operating bandwidths.

FIG. 5 illustrates a block diagram of an exemplary base station, such as those shown in FIG. 1, showing various components for implementing embodiments of the present subject matter.

FIG. 6 is a block diagram of the MTC device showing various components for implementing embodiments of the present subject matter.

The drawings described herein are for illustration purposes only and are not intended to limit the scope of the present disclosure in any way.

### MODE FOR THE INVENTION

The present invention provides a method and system of communication with low cost MTC devices. In the following detailed description of the embodiments of the invention, reference is made to the accompanying drawings that form a part hereof, and in which are shown by way of illustration specific embodiments in which the invention may be practiced. These embodiments are described in sufficient detail to enable those skilled in the art to practice the invention, and it is to be understood that other embodiments may be utilized and that changes may be made without departing from the scope of the present invention. The following detailed description is, therefore, not to be taken in a limiting sense, and the scope of the present invention is defined only by the appended claims.

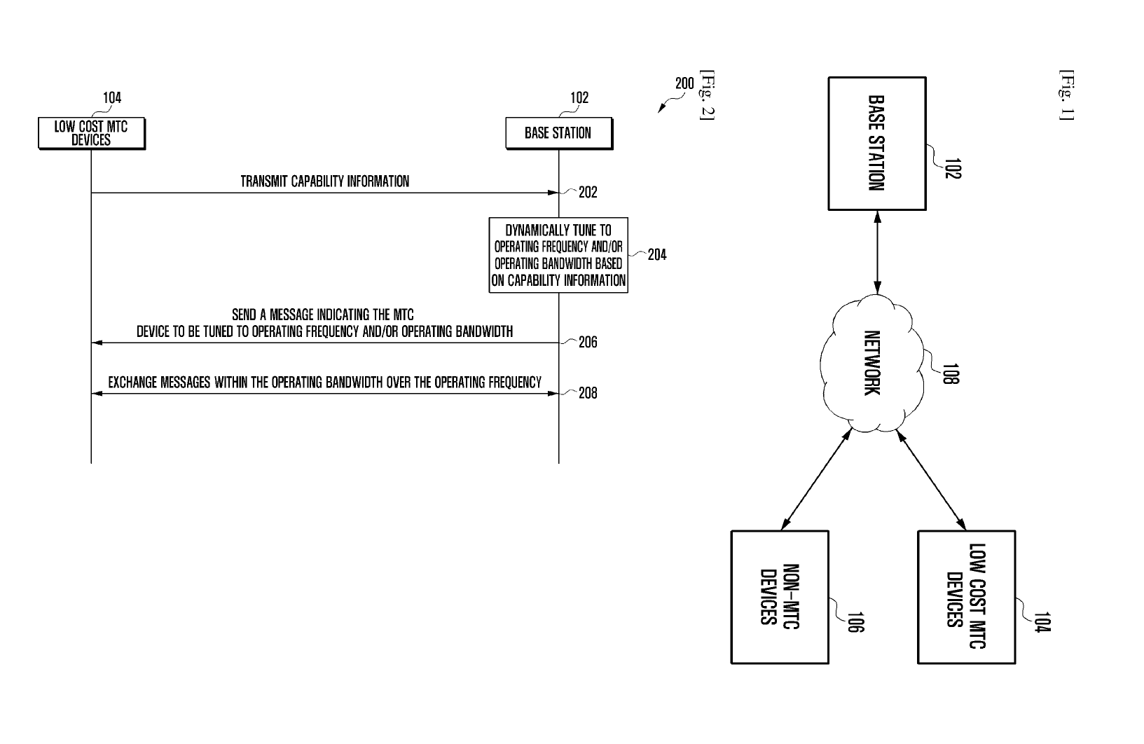

FIG. 1 illustrates a block diagram of an exemplary wireless communication system 100, according to one embodiment. In FIG. 1, the wireless communication system 100 includes a base station 102, a set of low cost machine type communication (MTC) devices 104, non-MTC devices 106, and a network 108. The base station 102 is connected to the MTC devices 104 and the non-MTC devices 106 via the network 108. For example, the base station 102 may be a evolved node B (eNodeB) in a Long Term Evolution (LTE) communication system. The low cost MTC devices 104 may be a user equipment (e.g., mobile terminal) capable of machine to machine communication using a low cost LTE modem. The low cost MTC devices 104 is capable of communicating with the base station 100 over a narrow bandwidth (e.g., 1.4 Mhz) compared to maximum bandwidth (e.g., 20 Mhz) supported by the base station 102. The non-MTC devices 106 include legacy devices such as a cellular phone.

According to the present invention, the base station 102 and the MTC devices 104 communicates with each other over a narrow bandwidth and a specific frequency supported by the respective MTC devices 104. In other words, the base station 102 adjusts scheduling and communication of message with the MTC devices 104 based on operating frequency and operating bandwidth supported by the respective MTC devices 104 while scheduling and communicating with the non-MTC devices 106 in the maximum bandwidth supported by the non-MTC devices 106.

It is important to note that, in the conventional wireless communication system 100, a base station and MTC device communicate each other over a frequency, and a bandwidth operated across a center frequency associated with a serving cell.

FIG. 2 is a process flowchart 200 illustrating an exemplary method of tuning the low cost MTC device 104 to an operating frequency and operating bandwidth supported by the MTC device 104, according to one embodiment. As described earlier, the low cost MTC devices 104 is capable of communicating messages (control and data) with the base station 102 over a narrow bandwidth (e.g., 1.25 Mhz, 1.4 Mhz. 3 Mhz, 5 MHz, etc.) compared to legacy devices 106 (e.g., non-MTC devices such as cellular phone) which supports bandwidth of 20 Mhz. The base station 102 is desired to configure the MTC devices 104 to the narrow bandwidth such that the MTC devices 104 coexist with the non-MTC devices 106 in a maximum bandwidth supported by the base station 102. The process by which the base station 102 can tune MTC devices 104 is given in steps 202-210 below.

At step 202, the MTC device 104 transmits capability information to the base station 102. The capability information includes identity associated with the MTC device 104, an operating frequency and an operating bandwidth supported by the MTC device 104, antenna configuration information, support for number of radio frequency (RF) chains, and/or half duplex configuration.

At step 204, the base station 102 tunes the MTC device 104 to the operating frequency and the operating bandwidth supported by the MTC device 104 based on the capability information. In one exemplary implementation, the base station 102 tunes the MTC device 104 to a reduced operating bandwidth indicated in the capability information within a maximum bandwidth supported by the base station 102. In another exemplary implementation, the base station 102 tunes the MTC device 104 to a desired frequency indicated in the capability information.

At step 206, the base station 102 sends a message indicating the MTC device 104 to be tuned to operating frequency and/or the operating bandwidth. At step 208, the base station 102 and the MTC device 104 exchange messages (control messages and/or data messages) within the operating bandwidth over the operating frequency. For example, if the MTC device 104 is tuned to an operating bandwidth of 1.4 Mhz, the base station 102 transmits messages in the 1.4 Mhz bandwidth in downlink direction. Also, the MTC device 104 transmits messages in the 1.4 Mhz bandwidth in uplink direction.

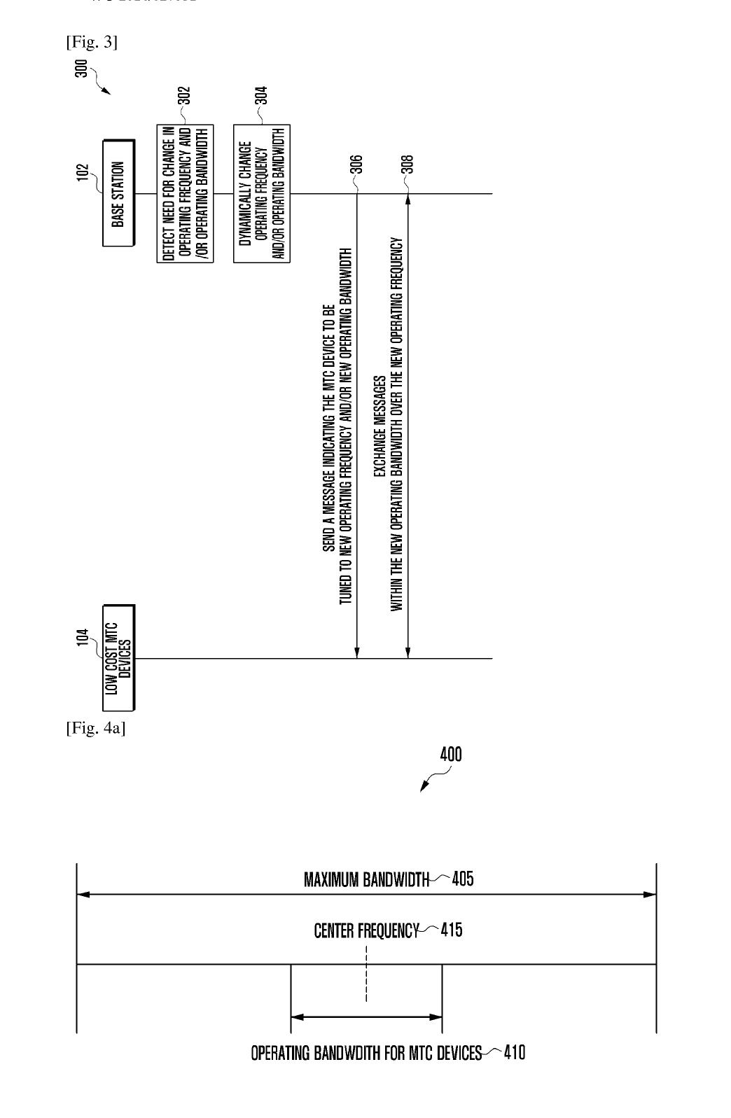

FIG. 3 is a flow diagram 300 illustrating an exemplary method of changing operating frequency and/or operating bandwidth of the MTC device, according to one embodiment. At step 302, the base station 102 detects a need to change current operating frequency and operating bandwidth of the MTC device 104 to another operating frequency and/or operating bandwidth. The current operating frequency and the operating bandwidth are in use for exchanging messages between the base station 102 and the MTC device 104. It can be noted that, the current operating frequency and operating bandwidth and the new operating frequency and/or the operating bandwidth are supported by the MTC device 104.

At step 304, the base station 102 tunes the MTC device 104 to the new operating frequency and/or operating bandwidth. At step 306, the base station 104 sends a message indicating the MTC device to be tuned to the new operating frequency and/or bandwidth. For example, the message indicating that the MTC device is tuned to the new operating frequency and/or bandwidth may include a handover message or any other signaling message. At step 308, the base station 102 exchanges messages within the new operating bandwidth over the new operating frequency.

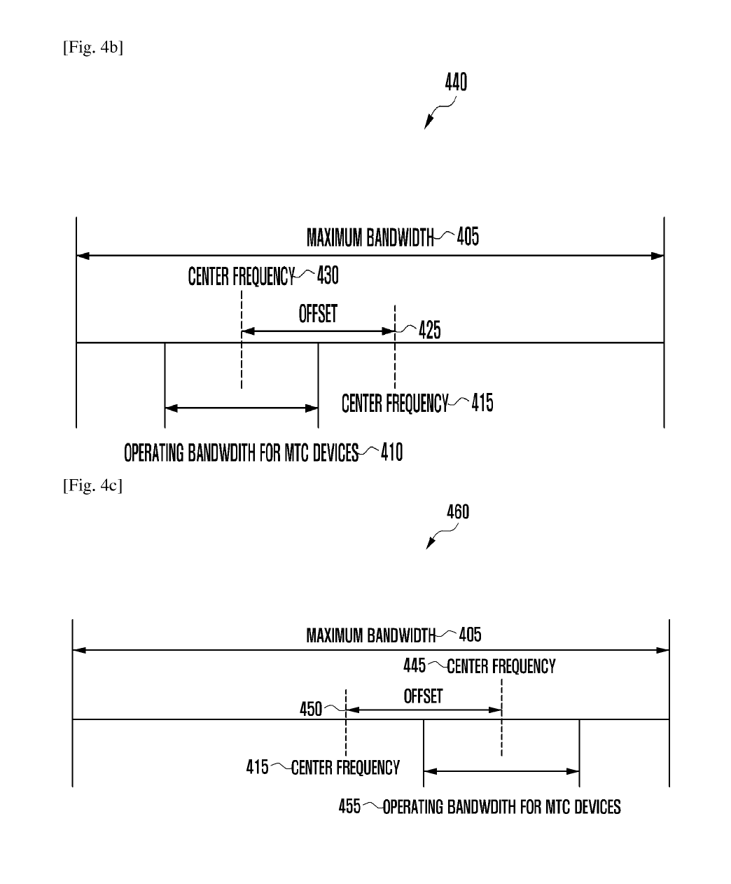

FIGS. 4A to 4C are schematic representations 400, 440 and 460 illustrating tuning of the MTC device 104 to different operating frequencies and different operating bandwidths. In FIG. 4A, the maximum bandwidth 405 is the bandwidth supported by the base station 102. The MTC device 104 is supports center frequency 415 and the operating bandwidth 410. For example, the maximum bandwidth 405 may be 20 Mhz and the operating bandwidth supported by the MTC device 104 may be 1.4 Mhz. The MTC device 104 communicates the support for center frequency 415 and the operating bandwidth 410 to the base station 102 during connection establishment. In such case, the base station 102 tunes the MTC device 104 to the center frequency 415 and the operating bandwidth 410. Accordingly, the base station 102 and the MTC device 104 exchanges messages within the operating bandwidth 410 over the center frequency 415. The base station 102 exchanges messages with non-MTC devices 106 (also commonly known as legacy user equipments) within the maximum bandwidth 405. In this manner the MTC devices 104 coexist with the non-MTC devices 106 within the maximum bandwidth supported by a serving cell (e.g., a macro cell).

In a second scenario depicted in FIG. 4B, the MTC device 104 supports operating frequency 430 which is at an offset 425 from the center frequency 415. In this scenario, the operating bandwidth is same but frequency is different with respect to scenario illustrated in FIG. 4A. During connection establishment, the MTC device 104 indicates support for the operating frequency 430 and the operating bandwidth 410 to the base station 102. In such case, the base station 102 tunes the MTC device 104 to the operating frequency 430 and the operating bandwidth 410. Accordingly, the MTC device 104 and the base station 102 exchange messages within the operating bandwidth 410 over the operating frequency 430.

In a third scenario depicted in FIG. 4C, the MTC device 104 supports operating frequency 445 which is at an offset 450 from the center frequency 415 and operating bandwidth 455. In this scenario, both the operating frequency 445 and the operating bandwidth 455 are different from the scenario depicted in FIG. 4A. In this scenario, the operating bandwidth 455 is larger than the operating bandwidth 410 in FIG. 4A and FIG. 4B. When the MTC device 104 communicates the support for the operating frequency 445 and the operating bandwidth 455, the base station 102 tunes the MTC device 102 to the operating frequency 445 and the operating bandwidth 455. Accordingly, the MTC device 104 and the base station 102 exchange messages within the operating bandwidth 455 over the operating frequency 445. One skilled in the art will understand the base station 102 is capable of tuning the operating frequency and the operating bandwidth supported by the MTC device 104. In this manner, the MTC devices 104 can be tuned to any operating frequency and any operating bandwidth supported by the MTC devices 104 within the maximum bandwidth supported by the serving cell. Further, the base station 104 can dynamically change the operating frequency and the operating bandwidth even after connection establishment, where the operating frequency and the operating bandwidth falls within frequency range and maximum bandwidth supported by the MTC devices 104. Although, the above scenario illustrates tuning of operating frequency and operating bandwidth for single MTC device, one skilled in the art will understand that tuning operation can be applied for a group of MTC devices or a plurality of multiple MTC devices supporting different operating frequencies and different bandwidths.

In an exemplary implementation, consider that the maximum bandwidth 405 supported by a Long Term Evolution (LTE) network is 20 Mhz. Also, consider that, the operating frequency supported by the MTC device 104 is center frequency and the operating bandwidth supported by the MTC device 104 is 1.4 Mhz. Referring to FIG. 4A, when the MTC device 104 wishes to camp on the base station 102, the MTC device 104 listens to synchronization signals and then decodes physical broadcast channel (PBCH) for master information block (MIB). According to the present invention, the base station 102 transmits synchronization signals and PBCH for MIB in the center of the 1.4 Mhz bandwidth so that the MTC devices 104 and the non-MTC devices 106 receive the synchronization signals and the PBCH in the 1.4 Mhz bandwidth. Following the synchronization signals and the PBCH, the base station 102 transmits system information blocks (SIBs) over physical downlink shared channel (PDSCH) in center of 1.4 Mhz bandwidth on the center frequency 415 so that the MTC devices 104 and non-MTC devices 106 also listen to the SIBs simultaneously. Upon decoding the SIBs, the MTC device 104 triggers a Random Access Channel (RACH) procedure for connection establishment.

The base station 102 transmits PRACH and message 3 within the center of 1.4 Mhz bandwidth. Also, the base station 102 transmits the message 2/4 of the RACH procedure in Physical Downlink Shared Channel (PDSCH) within the 1.4 MHz bandwidth. Further, the base station 102 transmits grants for message 2/4 and HARQ-ACK for message 3 on Physical Hybrid-ARQ Indicator Channel (PHICH) in a duplicated manner so that the MTC devices 104 and the non-MTC devices 106 receive the grants and HARQ-ACK. In one exemplary embodiment, the base station 102 transmits the RACH resources in a SIB2 message. The base station 102 allocates different RACH resources to distinguish between the MTC devices 104 and the non-MTC devices 106. For example, the base station 102 may allocate center 1.4 MHZ bandwidth for the MTC devices 104 and the remaining of the 20 Mhz bandwidth for the non-MTC devices 106, according to the embodiment shown in FIG. 4A. Alternatively, the base station 102 may allocate 1.4 Mhz bandwidth in non-center region of the 20 Mhz bandwidth to the MTC devices 104, according to the embodiment illustrated in FIGS. 4B and 4C. Alternatively, the base station 102 may use new information elements in the SIB2 to distinguish between the MTC devices 104 and the non-MTC devices 106. For example, the base station 102 may use MTC specific RACH channel definition. Other ways by which the base station 102 can distinguish between the MTC devices 104 and the non-MTC devices 106 includes but not limited to preamble reservation, RACH time resource reservation or time resource differentiation.

Based on the respective RACH resources, the MTC devices 104 and the non-MTC devices 106 can perform RACH procedure with the base station 102 for establishment of a connection. The steps involved in performing a RACH procedure using RACH resources is well known to the person skilled in the art and hence the explanation is thereof omitted. Upon successfully completion of the RACH procedure, the MTC device 104 establishes a connection with the base station 102. After connection establishment, the MTC device 104 sends capability information to the base station 102 (step 202 of FIG. 2). For example, the capability information may indicate identifier indicating that the MTC device 104 is a low cost MTC device, support of DL/UL bandwidth, maximum bandwidth supported in respective bands, antenna configuration information, half duplex operation, and support for number of RF chains. The MTC device 104 may transmit capability information in a capability indication message, a RRC connection request message, and RRC connection setup complete message. The MTC device 104 may indicate the capability information in a new information element in the capability indication message, the RRC connection request message, or the RRC connection setup complete message. It can be noted that the MTC device 104 transmits capability information in one or more steps. For example, a part of capability information is transmitted during the RACH procedure and the remaining part of the capability information is transmitted in a capability indication message.

Based on the capability information, the base station 102 adjusts scheduling and communication to the MTC device 104. It can be noted that prior to knowing support of bandwidth, the base station 102 communicates with the MTC device in a minimum possible bandwidth (e.g., 1.4 Mhz) either in central region of the maximum bandwidth or a non-central region of the maximum bandwidth.

In accordance with the foregoing description, the low cost MTC device 104 may be working in a half-duplex configuration. The half duplex configuration may be performed in either UL/DL carrier of a macro cell (e.g., the base station 102). When the MTC device 104 operates in a central frequency region 415 of corresponding carrier (e.g., both UL and DL), no frequency tuning is required for the MTC device 104 for UL and DL operation. The base station 102 tunes an UL bandwidth and a downlink bandwidth supported by the MTC device 104 adjacent to each other and around an operating frequency supported by the MTC device 104. In some embodiments, the base station 102 tunes the UL bandwidth and the DL bandwidth over an uplink carrier and/or downlink carrier of the macro cell.

Further, when the MTC device 104 is configured in a Half duplex operation, avoiding collision of physical random access channel (PRACH) with PDSCH/physical data link control channel (PDCCH) becomes important and in order to analyze the collision chances, following steps are carried out during the RACH procedure:

i) Initial access from Radio Resource Control (RRC) idle—No issue as there is no channel in DL (RACH transmission based on the index in SIB-2);

ii) RRC Connection Re-establishment procedure;

iii) After a Handover—the base station 102 can assign RACH resources in an UL area so as to avoid the collision. The RACH resources inform the MTC device 104 what and when to transmit messages;

iv) DL data arrival during RRC connected mode requiring random access procedure (e.g., when UL synchronization status is non-synchronised);

v) UL data arrival during RRC connected mode requiring random access procedure (e.g., when UL synchronization status is non-synchronized or there are no physical uplink control channel (PUCCH) resources for available scheduling request); and

vi) For positioning purpose during RRC connected mode requiring random access procedure (e.g., when timing advance is needed for positioning of the MTC device 104).

For steps iv), v), and vi), the base station 102 indicates a RACH configuration index so that the MTC device 104 selects a UL subframe to transmit a PRACH. In one exemplary implementation, the base station 102 indicates RACH configuration index during establishment of a radio resource connection. In case, the base station 102 assigns a generic RACH configuration index, then the MTC device 104 selects RACH transmission area based on previous UL transmission so as to avoid the collision with PDCCH/PDSCH. The MTC device 104 ensures that PRACH is transmitted in the beginning of the UL frame (based on previous transmissions) so as to avoid the spill over to DL frame.

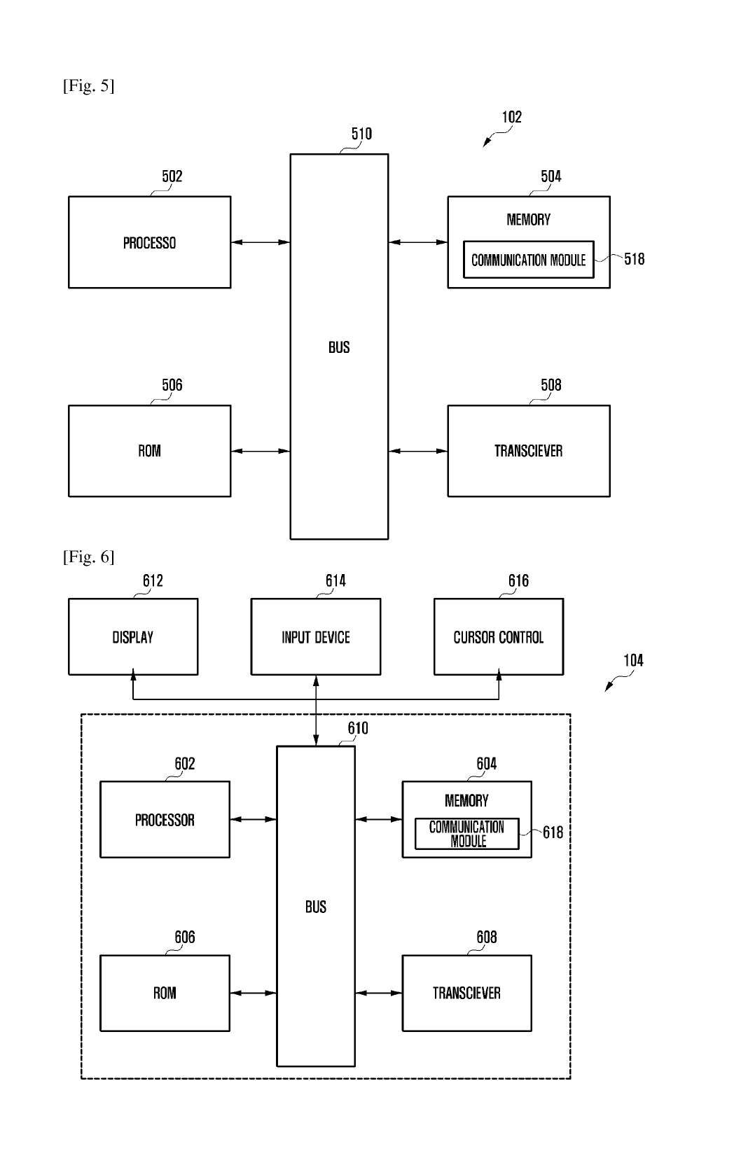

FIG. 5 illustrates a block diagram of the base station 102 showing various components for implementing embodiments of the present subject matter. In FIG. 5, the base station 102 includes a processor 502, a memory 504, a read only memory (ROM) 506, a transceiver 508, and a bus 510.

The processor 502, as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a graphics processor, a digital signal processor, or any other type of processing circuit. The processor 502 may also include embedded controllers, such as generic or programmable logic devices or arrays, application specific integrated circuits, single-chip computers, smart cards, and the like.

The memory 504 and the ROM 506 may be volatile memory and non-volatile memory. The memory 504 includes a communication module 512 for tuning operation frequency and/or operation bandwidth and communicating with MTC devices 104 within the operation bandwidth over the operation frequency, according to one or more embodiments described above. A variety of computer-readable storage media may be stored in and accessed from the memory elements. Memory elements may include any suitable memory device(s) for storing data and machine-readable instructions, such as read only memory, random access memory, erasable programmable read only memory, electrically erasable programmable read only memory, hard drive, removable media drive for handling compact disks, digital video disks, diskettes, magnetic tape cartridges, memory cards, and the like.

Embodiments of the present subject matter may be implemented in conjunction with modules, including functions, procedures, data structures, and application programs, for performing tasks, or defining abstract data types or low-level hardware contexts. The communication module 512 may be stored in the form of machine-readable instructions on any of the above-mentioned storage media and may be executed by the processor 502. For example, a computer program may include machine-readable instructions which when executed by the processor 502, may cause the processor 502 to tune the MTC devices 104 to operating frequency and/or operating bandwidth, and communicate with the MTC devices 104 within the operating bandwidth over the operating frequency, according to the teachings and herein described embodiments of the present subject matter. In one embodiment, the program may be included on a compact disk-read only memory (CD-ROM) and loaded from the CD-ROM to a hard drive in the non-volatile memory.

The transceiver 508 may be capable of communicating messages with the MTC devices 104 and the non-MTC devices 106. The bus 510 acts as interconnect between various components of the base station 102.

FIG. 6 is a block diagram of the MTC device 104 showing various components for implementing embodiments of the present subject matter. In FIG. 6, the MTC device 104 includes a processor 602, memory 604, a read only memory (ROM) 606, a transceiver 608, a bus 610, a display 612, an input device 614, and a cursor control 616.

The processor 602, as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a graphics processor, a digital signal processor, or any other type of processing circuit. The processor 602 may also include embedded controllers, such as generic or programmable logic devices or arrays, application specific integrated circuits, single-chip computers, smart cards, and the like.

The memory 604 and the ROM 606 may be volatile memory and non-volatile memory. The memory 604 includes a communication module 618 for transmitting capability information associated with the MTC device 104 to the base station 102, tuning operating frequency and/or operating bandwidth supported by the MTC device 104 and communicating messages with the base station 102 within the operating bandwidth over the operating frequency, according to one or more embodiments described above. A variety of computer-readable storage media may be stored in and accessed from the memory elements. Memory elements may include any suitable memory device(s) for storing data and machine-readable instructions, such as read only memory, random access memory, erasable programmable read only memory, electrically erasable programmable read only memory, hard drive, removable media drive for handling compact disks, digital video disks, diskettes, magnetic tape cartridges, memory cards, and the like.

Embodiments of the present subject matter may be implemented in conjunction with modules, including functions, procedures, data structures, and application programs, for performing tasks, or defining abstract data types or low-level hardware contexts. The communication module 618 may be stored in the form of machine-readable instructions on any of the above-mentioned storage media and may be executed by the processor 602. For example, a computer program may include machine-readable instructions, that when executed by the processor 602, cause the processor 602 to transmit capability information associated with the MTC device 104 to the base station 102, tune operating frequency and/or operating bandwidth supported by the MTC device 104 and communicate messages with the base station 102 within the operating bandwidth over the operating frequency, according to the teachings and herein described embodiments of the present subject matter. In one embodiment, the computer program may be included on a compact disk-read only memory (CD-ROM) and loaded from the CD-ROM to a hard drive in the non-volatile memory.

The transceiver 608 may be capable of transmitting capability information and communicating messages with the base station 102. The bus 610 acts as interconnect between various components of the MTC device 104. The components such as the display 612, the input device 614, and the cursor control 616 are well known to the person skilled in the art and hence the explanation is thereof omitted.

The present embodiments have been described with reference to specific example embodiments, it will be evident that various modifications and changes may be made to these embodiments without departing from the broader spirit and scope of the various embodiments. Furthermore, the various devices, modules, and the like described herein may be enabled and operated using hardware circuitry, for example, complementary metal oxide semiconductor based logic circuitry, firmware, software and/or any combination of hardware, firmware, and/or software embodied in a machine readable medium. For example, the various electrical structure and methods may be embodied using transistors, logic gates, and electrical circuits, such as application specific integrated circuit.

1. A method of communicating with low cost machine type communication (MTC) devices, comprising:
dynamically tuning, by a base station, at least one MTC device to at least one of an operating frequency and an operating bandwidth supported by the at least one MTC device; and
communicating messages with the at least one MTC device within the operating bandwidth over the operating frequency.

2. The method of claim 1, further comprising:
receiving capability information from the at least one MTC device, wherein the capability information includes at least one of an identifier associated with the at least one MTC device, the operating frequency and the operating bandwidth supported by the at least one MTC device, antenna configuration, half duplex configuration and support for number of radio frequency chains.

3. The method of claim 2, wherein dynamically tuning the operating frequency and the operating bandwidth supported by the at least one MTC device comprises:
dynamically tuning at least one of the operating frequency and the operating bandwidth supported by the at least one MTC device based on the capability information.

4. The method of claim 3, wherein dynamically tuning at least one of the operating frequency and the operating bandwidth supported by the at least one MTC device based on the capability information comprises:
tuning an operating uplink bandwidth and operating downlink bandwidth adjacent to each other and around an operating frequency supported by the MTC device if the half duplex configuration is enabled for the at least one MTC device.

5. The method of claim 1, further comprising:
dynamically changing at least one of the operating frequency and the operating bandwidth supported by the at least one MTC device.

6. The method of claim 1, further comprising:
allocating resources to the at least one MTC device based on the operating frequency and the operating bandwidth supported by the at least one MTC device.

7. The method of claim 1, further comprising:
transmitting a synchronization signals to the at least one MTC device in a minimum bandwidth supported by the at least one MTC device.

8. The method of claim 7, further comprising:
transmitting a master information block (MIB) to the at least one MTC device in a minimum bandwidth supported by the at least one MTC device.

9. The method of claim 8, further comprising:
transmitting a system information block (SIB) to the at least one MTC device in the minimum bandwidth supported by the at least one MTC device.

10. The method of claim 9, further comprising:
transmitting a Radio Access Channel (RACH) resources to the at least one MTC device in the minimum bandwidth supported by the at least one MTC device.

11. An apparatus comprising:
a processor; and
a memory coupled to the processor, wherein the memory comprises a communication module configured for:
dynamically tuning at least one MTC device to at least one of an operating frequency and an operating bandwidth supported by the at least one MTC device; and
communicating messages with the at least one MTC device within the operating bandwidth over the operating frequency.

12. A method of tuning a machine type communication (MTC) device, comprising:
receiving a message indicating operating frequency and operating bandwidth tuned for the MTC device from a base station;
tuning the MTC device to the operating frequency and the operating bandwidth based on the received message; and
communicating with the base station within the operating bandwidth over the operating frequency.

13. The method of claim 12, further comprising:
sending capability information of the MTC device to the base station, wherein the capability information includes at least one of an identifier associated with the at least one MTC device, the operating frequency and the operating bandwidth supported by the at least one MTC device, antenna configuration, support for number of radio frequency (RF) chains, and half duplex configuration.

14. The method of claim 12, further comprising:
establishing a connection with the base station by performing a radio access channel (RACH) procedure using RACH resources allocated by the base station.

15. An apparatus comprising:
a processor; and
a memory coupled to the processor, wherein the memory comprises a communication module configured for:
receiving a message indicating operating frequency and operating bandwidth to be tuned from a base station;
tuning the operating frequency and the operating bandwidth based on the received message; and
communicating with the base station within the operating bandwidth over the operating frequency.
